(19) United States
(12) Patent Application Publication
(10) Pub. No.: US 2025/0370489 A1
(43) Pub. Date: Dec. 4, 2025

(54) POWER DELIVERY SYSTEM

(71) Applicant: Power Forest Technology Corporation, Hsinchu County (TW)

(72) Inventors: Rong-Jie Tu, Hsinchu County (TW); Shih Yuan Huang, Hsinchu County (TW)

(73) Assignee: Power Forest Technology Corporation, Hsinchu County (TW)

(21) Appl. No.: 18/744,706

(22) Filed: Jun. 17, 2024

(30) Foreign Application Priority Data
Jun. 3, 2024 (TW) 113205783

(51) Int. Cl. G05F 1/46

(52) U.S. Cl. CPC G05F 1/46

(57) ABSTRACT

A power delivery system is provided. A power supply device provides a vendor defined message to a power reception device via a configuration channel pin to request the power reception device to enter a low power mode. In the low power mode, the power supply device controls a pull-up circuit to stop providing a current to the configuration channel pin when declaring that a status of the pull-up circuit is SinkTxOK.

### CROSS-REFERENCE TO RELATED APPLICATION

This application claims the priority benefit of Taiwan application serial no. 113205783, filed on Jun. 3, 2024. The entirety of the above-mentioned patent application is hereby incorporated by reference herein and made a part of this specification.

### BACKGROUND

### Technical Field

The disclosure relates to an electronic device, and more particularly, to a power delivery system.

### Description of Related Art

The Universal Serial Bus (USB) Type-C specification connector can simultaneously support data, audio, video transmission, reversible plugging, and high-efficiency charging functions and has the characteristics of high compatibility and high transmission rate, and therefore is widely used in information and communication devices. For example, electronic devices such as smartphones, laptops, desktop computers, game consoles have begun to use the USB Type-C transmission interface.

Generally speaking, when charging via the USB Type-C interface, the power supply device and the power reception device need to communicate through the power delivery (PD) protocol via the configuration channel (CC) pin to determine the charging specifications. The power supply device can confirm the connection status with the power reception device by pulling up the current provided by the pull-up resistor in the power supply device.

### SUMMARY

The disclosure provides a power delivery system that can effectively reduce the power consumption of the power delivery system.

A power delivery system of the disclosure includes a power reception device, a configuration channel pin, and a power supply device. The power reception device includes a pull-down resistor. The power supply device includes a pull-up circuit. The pull-up circuit is coupled to the pull-down resistor via the configuration channel pin. The power supply device provides a vendor defined message to the power reception device via the configuration channel pin to request the power reception device to enter a low power mode. In the low power mode, the power supply device controls the pull-up circuit to stop providing a current to the configuration channel pin when declaring that a status of the pull-up circuit is SinkTxOK.

In an embodiment of the disclosure, the power supply device controls the pull-up circuit to provide a preset current when declaring that the status of the pull-up circuit is SinkTxNG.

In an embodiment of the disclosure, the preset current is 80 uA or 180 uA.

In an embodiment of the disclosure, in response to the power reception device not supporting the low power mode, the power supply device enters a normal mode. In the normal mode, the power supply device controls the pull-up circuit to provide a first preset current when declaring that the status of the pull-up circuit is SinkTxOK, and the power supply device controls the pull-up circuit to provide a second preset current when declaring that the status of the pull-up circuit is SinkTxNG. The first preset current is greater than the second preset current.

In an embodiment of the disclosure, the first preset current is 330 uA, and the second preset current is 80 uA or 180 uA.

In an embodiment of the disclosure, the pull-up circuit is a current source.

In an embodiment of the disclosure, a resistance value of the pull-down resistor is 5.1 ohms.

In an embodiment of the disclosure, the pull-up circuit includes a resistor circuit and a switch circuit. The resistor circuit is coupled between a reference voltage and a configuration channel pin. The switch circuit is coupled between the resistor circuit and the configuration channel pin. The power supply device controls a conduction status of the switch circuit and adjusts a resistance value of the resistor circuit so as to control the current provided by the pull-up circuit to the configuration channel pin.

In an embodiment of the disclosure, the power supply device controls the switch circuit to turn off when declaring that the status of the pull-up circuit is SinkTxOK so as to control the pull-up circuit to stop providing the current to the configuration channel pin.

In an embodiment of the disclosure, the power supply device controls the switch circuit to turn on and adjusts the resistance value of the resistor circuit when declaring that the status of the pull-up circuit is SinkTxNG so as to control the pull-up circuit to provide the preset current.

Based on the above, the power supply device of the disclosure can provide the vendor defined message to the power reception device via the configuration channel pin to request the power reception device to enter the low power mode. In the low power mode, the power supply device controls the pull-up circuit to stop providing the current to the configuration channel pin when declaring that the status of the pull-up circuit is SinkTxOK. In this way, after the vendor defined message is used to make the power supply device and the power reception device enter the low power mode, the pull-up circuit is controlled to stop providing the current to the configuration channel pin, and the voltage on the corresponding configuration channel pin is set to 0 volts when the status of the pull-up circuit is declared to be SinkTxOK, so that the power consumption of the power delivery system can be effectively reduced.

### BRIEF DESCRIPTION OF THE DRAWINGS

FIG. 1 is a schematic diagram of a power delivery system according to the disclosure.

FIG. 2 is a schematic diagram of a power delivery system according to another embodiment of the disclosure.

### DESCRIPTION OF THE EMBODIMENTS

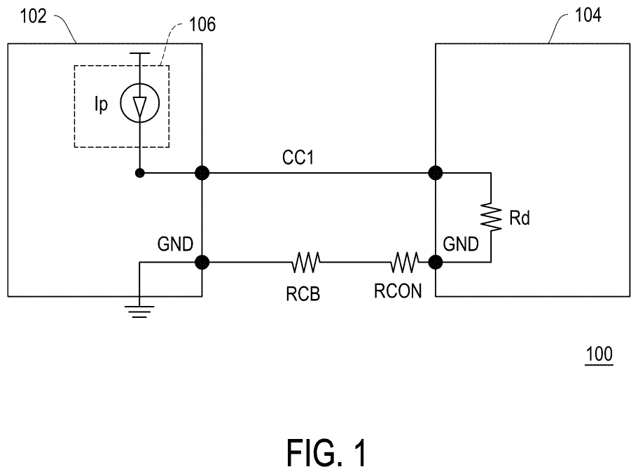

FIG. 1 is a schematic diagram of a power delivery system according to the disclosure. A power delivery system 100 includes a power supply device 102, a configuration channel pin CC1, and a power reception device 104. The power supply device 102 is coupled to the power reception device 104 via the configuration channel pin CC1, that is to say, the power supply device 102 and the power reception device 104 are connected via the USB Type-C interface. The power supply device 102 may be, for example, a charger or an adapter, and the power reception device 104 may be, for example, an electronic device such as a mobile phone, a laptop, a desktop computer, a game console, but the disclosure is not limited thereto.

Furthermore, the power delivery integrated circuit (PDIC) of the power supply device 102 may include a pull-up circuit 106. The pull-up circuit 106 is coupled to the configuration channel pin CC1 and coupled to a pull-down resistor Rd of the power reception device 104 via the configuration channel pin CC1. The pull-down resistor Rd is coupled between the configuration channel pin CC1 and the ground GND. A resistance value of the pull-down resistor Rd may be, for example, 5.1 ohms, but the disclosure is not limited thereto. In addition, a resistor RCB and a resistor RCON are connected in series between ground terminals of the power supply device 102 and the power reception device 104. The resistor RCB represents a resistance of the cable, and the resistor RCON represents a contact resistance.

The pull-up circuit 106 of the power supply device 102 can be used to provide a current to the configuration channel pin CC1 to change a voltage on the configuration channel pin CC1 and confirm a connection status with the power reception device 104 based on the voltage on the configuration channel pin CC1. In the embodiment, the pull-up circuit 106 includes a current source Ip. The power supply device 102 can adjust a current provided by the current source Ip to change the voltage on the configuration channel pin CC1. In addition, the power supply device 102 can provide a vendor defined message (VDM) to the power reception device 104 via the configuration channel pin CC1 to request the power reception device 104 to enter a low power mode defined by the vendor defined message, and determine whether the power reception device 104 supports the low power mode based on a response command of the power reception device 104. When the power reception device 104 supports the low power mode, the power supply device 102 and the power reception device 104 enter the low power mode, and the power supply device 102 can perform communication and power transmission with the power reception device 104 based on a protocol of the vendor defined message.

In the low power mode, when the power supply device 102 declares that a status of the pull-up circuit 106 is SinkTxOK, that is, the power supply device 102 declares that the power reception device 104 is allowed to transmit data (such as transmitting an atomic message sequence (AMS) but not limited thereto) via the configuration channel pin CC1, the power supply device 102 can stop providing current by controlling the current source IP, and set the voltage on the configuration channel pin CC1 to 0 volts. In this way, the power reception device 104 can determine whether data can be transmitted to the power supply device 102 via the configuration channel pin CC1 based on whether the voltage on the configuration channel pin CC1 is 0 volts so as to prevent collisions. For example, the power reception device 104 can determine whether the voltage on the configuration channel pin CC1 remains at 0 volts for a preset time. If the voltage on the configuration channel pin CC1 remains at 0 volts for a preset time, it is determined that data can be transmitted to the power supply device 102 via the configuration channel pin CC1.

In addition, in the low power mode, when the power supply device 102 declares that the status of the pull-up circuit 106 is SinkTxNG, that is, when the power supply device 102 declares that the power reception device 104 is not allowed to transmit data via the configuration channel pin CC1, the corresponding voltage on the configuration channel pin CC1 may be, for example, 0.9 volts. The power supply device 102 may, for example, provide a preset current (such as 180 uA) by adjusting the current source IP so as to set the voltage on the configuration channel pin CC1 to 0.9 volts. It is worth noting that in other embodiments, the voltage on the corresponding configuration channel pin CC1 when the power supply device 102 declares that the status of the pull-up circuit 106 is SinkTxNG can also be set to other voltage values, such as 0.4 volts (the current source IP provides the preset current of 80 uA), but the disclosure is not limited thereto.

In this way, after the vendor defined message is used to make the power supply device 102 and the power reception device 104 enter the low power mode, the pull-up circuit 106 is controlled to stop providing the current to the configuration channel pin CC1, and the voltage on the corresponding configuration channel pin CCI when the status of the pull-up circuit 106 is declared to be SinkTxOK is set to 0 volts, which can effectively reduce the power consumption of the power delivery system 100. In some embodiments, the setting value of the voltage on the corresponding configuration channel pin CC1 when the power supply device 102 declares that the status of the pull-up circuit 106 is SinkTxNG can be further reduced so as to further reduce the power consumption of the power delivery system 100.

In addition, when the power reception device 104 does not support the low power mode, the power supply device 102 can enter a normal mode and perform communication and power transmission with the power reception device 104 based on the original power delivery protocol of the power delivery system. In the normal mode, when the power supply device 102 declares that the status of the pull-up circuit 106 is SinkTxOK, the power supply device 102 may, for example, control the current source IP to provide a first preset current so as to set the voltage on the configuration channel pin CC1 to 1.6 volts corresponding to the SinkTxOK status. In addition, when the power supply device 102 declares that the status of the pull-up circuit 106 is SinkTxNG, the power supply device 102 may, for example, control the current source IP to provide a second preset current (such as 80 uA or 180 uA) so as to set the voltage on the configuration channel pin CC1 to 0.4 or 0.9 volts. In this way, when the power reception device 104 does not support the low power mode, switching to the normal mode to perform communication and power transmission with the power reception device 104 based on the original power delivery protocol of the power delivery system 100 can make the use of the power delivery system 100 more flexible.

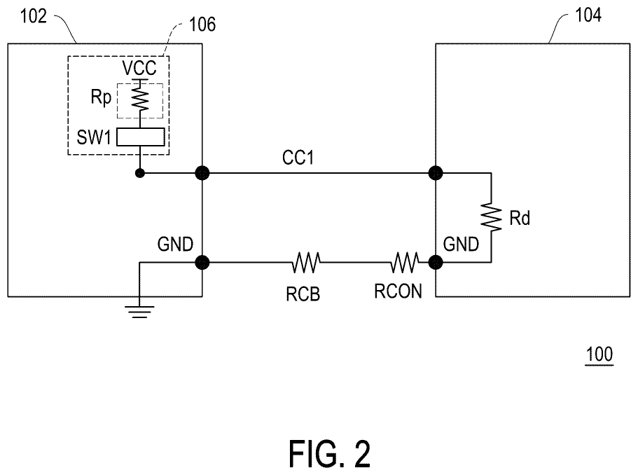

FIG. 2 is a schematic diagram of a power delivery system according to another embodiment of the disclosure. The difference from the embodiment in FIG. 1 is that in the embodiment, the pull-up circuit 106 may include a resistor circuit RP and a switch circuit SW1. The resistor circuit RP and the switch circuit SW1 are connected in series between a reference voltage VCC and the configuration channel pin CC1. The resistor circuit RP may include, for example, at least one resistor, and the switch circuit SW1 may be implemented, for example, in form of a transistor, but the disclosure is not limited thereto.

The power supply device 102 can control a conduction status of the switch circuit SW1 and adjust a resistance value of the resistor circuit RP so as to control the current provided by the pull-up circuit 106 to the configuration channel pin CC1. For example, the power supply device 102 can control the switch circuit SW1 to turn off when declaring that the status of the pull-up circuit 106 is SinkTxOK so as to control the pull-up circuit 106 to stop providing the current to the configuration channel pin CC1. In addition, when the status of the pull-up circuit 106 is declared to be SinkTxNG, the switch circuit SW1 can be controlled to be turned on and the resistance value of the resistor circuit RP can be adjusted so as to control the pull-up circuit to provide the preset current (such as 80 uA or 180 uA). The power supply device 102 sends the vendor defined message to the power reception device 104 to request the power reception device 104 to enter the low power mode defined by the vendor defined message. In the low power mode, the method of performing communication and power transmission with the power reception device 104 according to the protocol of the vendor defined message is the same as the above embodiment, and therefore a detailed description will be omitted. In some embodiments, the power supply device 102 can also change the current provided by the pull-up circuit 106 by, for example, adjusting the voltage value of the reference voltage VCC, but the disclosure is not limited thereto.

To sum up, the power supply device in the embodiment of the disclosure can provide the vendor defined message to the power reception device via the configuration channel pin to request the power reception device to enter the low power mode. In the low power mode, the power supply device controls the pull-up circuit to stop providing the current to the configuration channel pin when declaring that the status of the pull-up circuit is SinkTxOK. In this way, after the vendor defined message is used to make the power supply device and the power reception device enter the low power mode, the pull-up circuit is controlled to stop providing the current to the configuration channel pin, and the voltage on the corresponding configuration channel pin is set to 0 volts when the status of the pull-up circuit is declared to be SinkTxOK, so that the power consumption of the power delivery system can be effectively reduced.

What is claimed is:

1. A power delivery system, comprising:
a power reception device, comprising a pull-down resistor;
a configuration channel pin; and
a power supply device, comprising a pull-up circuit, wherein the pull-up circuit is coupled to the pull-down resistor via the configuration channel pin, the power supply device provides a vendor defined message to the power reception device via the configuration channel pin to request the power reception device to enter a low power mode, and in the low power mode, the power supply device controls the pull-up circuit to stop providing a current to the configuration channel pin when declaring that a status of the pull-up circuit is SinkTxOK.

2. The power delivery system according to claim 1, wherein the power supply device controls the pull-up circuit to provide a preset current when declaring that the status of the pull-up circuit is SinkTxNG.

3. The power delivery system according to claim 2, wherein the preset current is 80 uA or 180 uA.

4. The power delivery system according to claim 1, wherein in response to the power reception device not supporting the low power mode, the power supply device enters a normal mode, in the normal mode, the power supply device controls the pull-up circuit to provide a first preset current when declaring that the status of the pull-up circuit is SinkTxOK, and controls the pull-up circuit to provide a second preset current when declaring that the status of the pull-up circuit is SinkTxNG, and the first preset current is greater than the second preset current.

5. The power delivery system according to claim 4, wherein the first preset current is 330 uA, and the second preset current is 80 uA or 180 uA.

6. The power delivery system according to claim 1, wherein the pull-up circuit is a current source.

7. The power delivery system according to claim 1, wherein a resistance value of the pull-down resistor is 5.1 ohms.

8. The power delivery system according to claim 1, wherein the pull-up circuit comprises:
a resistor circuit, coupled between a reference voltage and the configuration channel pin; and
a switch circuit, coupled between the resistor circuit and the configuration channel pin, wherein the power supply device controls a conduction status of the switch circuit and adjusts a resistance value of the resistor circuit so as to control the current provided by the pull-up circuit to the configuration channel pin.

9. The power delivery system according to claim 8, wherein the power supply device controls the switch circuit to turn off when declaring that the status of the pull-up circuit is SinkTxOK so as to control the pull-up circuit to stop providing the current to the configuration channel pin.

10. The power delivery system according to claim 8, wherein the power supply device controls the switch circuit to turn on and adjusts the resistance value of the resistor circuit when declaring that the status of the pull-up circuit is SinkTxNG so as to control the pull-up circuit to provide a preset current.
